(19) United States
(12) Patent Application Publication
(10) Pub. No.: US 2011/0151798 A1
(43) Pub. Date: Jun. 23, 2011

(54) METHOD AND APPARATUS FOR SENSING MULTI-PATH SPECTRUM OF COGNITIVE RADIO SYSTEM AND COGNITIVE RADIO SYSTEM THEREOF

(75) Inventor: Sang-Won KIM, Daejeon (KR)

(73) Assignee: ELECTRONICS AND TELECOMMUNICATIONS RESEARCH INSTITUTE, Daejeon (KR)

(21) Appl. No.: 12/969,242

(22) Filed: Dec. 15, 2010

(30) Foreign Application Priority Data
Dec. 17, 2009 (KR) 10-2009-0125856
Feb. 2, 2010 (KR) 10-2010-0009401

(51) Int. Cl. H04B 17/00

(52) U.S. Cl. 455/67.11

(57) ABSTRACT

Provided is a multi-path spectrum sensing apparatus for a cognitive radio (CR) system. The multi-path spectrum sensing apparatus may include a spectrum sensing unit to sense at least one spectrum from a radio frequency (RF) input signal, using at least one of a broadband filter and a narrowband filter, and a processor to determine an occupation state of a channel corresponding to the at least one spectrum.

### CROSS-REFERENCE TO RELATED APPLICATION(S)

This application claims the benefit of Korean Patent Application Nos. 10-2009-0125856, and 10-2010-0009401, respectively filed on Dec. 17, 2009 and Feb. 2, 2010, in the Korean Intellectual Property Office, the disclosures of which are incorporated herein by references.

### BACKGROUND

1. Field of the Invention

The present invention relates to a spectrum sensing apparatus and method, and more particularly, to a multi-path spectrum sensing apparatus and method for a cognitive radio system.

2. Description of the Related Art

Frequency resources are being exhausted due to recent developments of mobile communication technologies and an increase in demands for frequency resources. A Cognitive radio (CR) technology that uses a TV white-space band may be a most applicable technology, and researches and standardization thereof have been actively conducted. The CR system may perform monitoring, in real time, to determine whether a frequency band is available to enable, without interference to existing users, a radio device to be available in a band where monitoring is not allowed.

Therefore, CR devices may sense various signals, such as a TV signal, a radio microphone signal, and the like in a TV band.

### SUMMARY

An aspect of the present invention provides a multi-path spectrum sensing apparatus and method that may sense signals of low levels and simultaneously determines a type of the signals using paths of multi-band.
Another aspect of the present invention also provides a multi-path spectrum sensing apparatus and method that may increase a including a spectrum sensing unit to sense at least one spectrum from a radio frequency (RF) input signal, using at least one of a broadband filter and a narrowband filter, and a processor to determine an occupation state of a channel corresponding to the at least one spectrum.

According to an aspect of the present invention, there is provided a CR system including a multi-path spectrum sensing apparatus to determine an occupation state of a channel, a Media Access Control layer (MAC) module to allocate at least one available spectrum band based on the occupation state of the channel, and a physical layer (PHY) module to set a channel based on the at least one allocated spectrum band.

According to an aspect of the present invention, there is provided a multi-path spectrum sensing method for a CR system, the method including sensing at least one spectrum from an RF input signal based on at least one of a broadband filter and a narrowband filter, and determining an occupation state of a channel corresponding to the at least one spectrum.

Additional aspects, features, and/or advantages of the invention will be set forth in part in the description which follows and, in part, will be apparent from the description, or may be learned by practice of the invention.

### EFFECT

According to embodiments, a signal-to-noise ratio (SNR) of a predetermined spectrum of a signal used in a band may increase, and a spectrum sensing result better than a conventional sensing level of a spectrum sensing algorithm may be obtained.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a multi-path spectrum sensing apparatus for a cognitive radio (CR) system according to an embodiment of the present invention;

FIG. 2 is a block diagram illustrating a multi-path spectrum sensing apparatus for a CR system according to another embodiment of the present invention;

FIG. 3 is a block diagram illustrating a multi-path spectrum sensing apparatus for a CR system according to a still another embodiment of the present invention;

FIG. 4 is a diagram illustrating a CR system including a multi-path spectrum sensing apparatus according to an embodiment of the present invention; and

FIG. 5 is a flowchart illustrating a multi-path spectrum sensing apparatus for a CR system according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

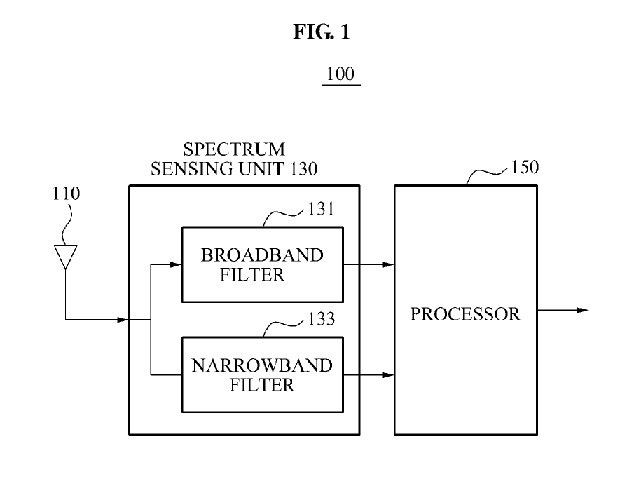

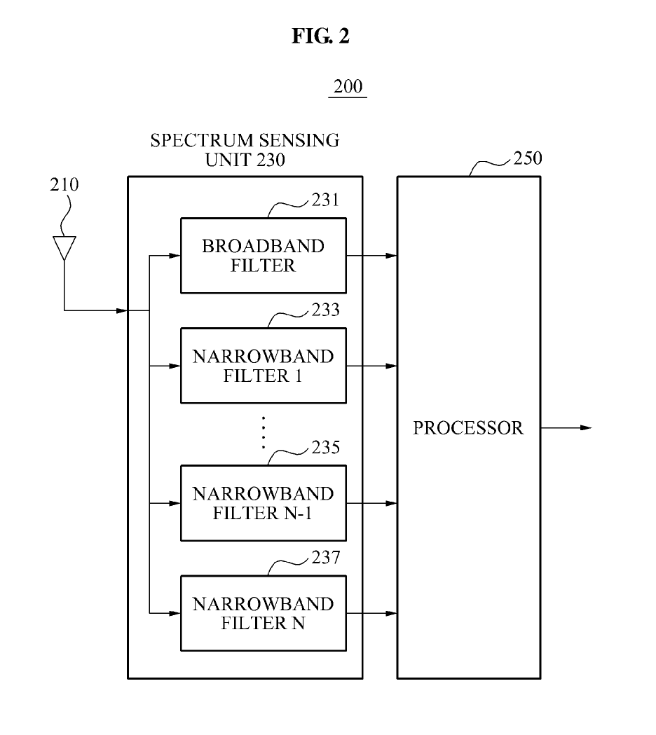

FIG. 1 illustrates a multi-path spectrum sensing apparatus for a cognitive radio (CR) system according to an embodiment of the present invention, and FIG. 2 illustrates a multi-path spectrum sensing apparatus for a CR system according to another embodiment of the present invention.

Referring to FIG. 1, the multi-path spectrum sensing apparatus for the CR system may include an antenna 110, a spectrum sensing unit 130, and a processor 150.

The antenna 110 may receive a radio frequency (RF) input signal and may provide the received RF input signal to the sensing unit 130. In this case, the antenna 110 may be a broadband antenna operating in a wide frequency band in a range of several MHz through several hundred GHz.

The spectrum sensing unit 130 may include at least one of a broadband filter and a narrowband filter, and may sense at least one spectrum, using the broadband filter 131 and the narrowband filter 133, from the RF input signal received by the antenna 110.

The broadband filter 131 may have the same band as a band available for the CR system, as a filtering band,

The narrowband filter 133 may be designed for filtering a well-known signal, such as a pilot signal, and may have a predetermined filtering band.

The narrowband filter 133 may be constituted of at least one narrowband filter, namely, one or more narrowband filters, and may have a variable center frequency and a variable bandwidth.

The spectrum sensing unit 130 may sense a full band of a desired signal using a multi-path, namely, a broadband frequency, a plurality of narrowbands, and the like, and simultaneously, may sense with respect to a narrowband, namely, location where a predetermined spectrum is expected and thus, may reduce a time expended for sensing the signal.

The sensing with respect to the narrowband may dramatically decrease a use of a digital filter tab included in a sensing algorithm executed in the processor 150.

The spectrum sensing unit 130 may include a plurality of narrowband filters 223, 235, 237 as illustrated in FIG. 2.

A sensing algorithm used in the multi-path spectrum sensing apparatus according to an embodiment of the present invention may use a spectrum element of a predetermined location from among signals in a frequency band and thus, the multi-path spectrum sensing apparatus may include a plurality of narrowband filters in a narrowband corresponding to the predetermined location.

At least one narrowband filter may be added in addition to the broadband filter and thus, a signal that is not sensed by the broadband filter may be sensed by the at least one added narrowband filter.

Elements of FIG. 2 having the same name as elements of FIG. 1 may have the same function and thus, omitted descriptions thereof may be understood based on the corresponding description of FIG. 1.

The spectrum sensing unit 130 may pass the RF input signal received by the antenna 110 through each of the broadband filter 131 and the narrowband filter 133 to sense at least one spectrum from the RF input signal.

The processor 150 may determine an occupation state of a channel corresponding to the at least one spectrum sensed by the spectrum sensing unit 130.

The processor 150 may determine the occupation state of the channel and a type of the channel based on a Cyclostationary algorithm. The Cyclostationary algorithm may be one of sensing algorithms used for cognizing a radio environment.

When the Cyclostationary algorithm is used, a power spectrum value with respect to a cyclic frequency of the desired signal may be calculated, and optimal statistics may be calculated based on the calculated power spectrum value and thus, the signal may be sensed based on the optimal statistics.

Generally, a sensing algorithm may sense a signal-to-noise ratio (SNR) and thus, a noise floor may need to be decreased. As a frequency bandwidth of the desired signal becomes narrower, the noise floor may decrease.

The multi-path spectrum sensing apparatus according to an embodiment may increase an SNR of a predetermined spectrum that is used in a band, using a narrowband filter. Therefore, a spectrum sensing result better than a conventional sensing level of the sensing algorithm may be obtained.

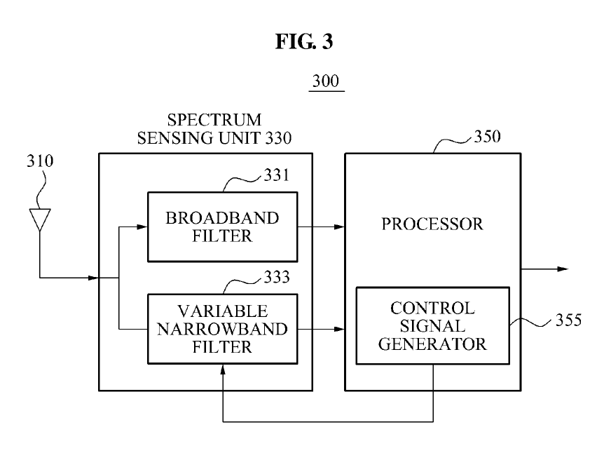

FIG. 3 illustrates a multi-path spectrum sensing apparatus 300 for a CR system according to a still another embodiment of the present invention.

Referring to FIG. 3, the multi-path spectrum sensing apparatus 300 for the CR system may include a spectrum sensing unit 330 and a processor 350. The spectrum sensing unit 330 may include a variable narrowband filter 333, and the processor 350 may include a control signal generator 355.

An antenna 310, a broadband filter 331, and the processor 350 having the same name as corresponding elements of FIG. 1 may have the same function as the corresponding elements of FIG. 1 and thus, omitted descriptions thereof may be understood based on the description of FIG. 1.

The variable narrowband filter 333 may be a narrowband filter of which a center frequency and a bandwidth of the narrowband filter are adjustable. The spectrum sensing unit 330 may adjust the center frequency and the bandwidth of the narrowband filter based on a control signal received from the processor 350 and thus, the narrowband filter may perform as the variable narrowband filter.

A signal that is not sensed during a broadband sensing operation may be sensed by the variable narrowband filter 333 of which the center frequency and the bandwidth are adjustable based on a spectrum feature of a signal desired to be monitored.

The processor 350 may include the control signal generator 355 to generate a control signal to adaptively adjust the center frequency and the bandwidth of the narrowband filter, namely, the variable narrowband filter 333.

Therefore, the center frequency and the bandwidth of the narrowband filter may be adjusted by the control signal based on the feature of the signal desired to be monitored.

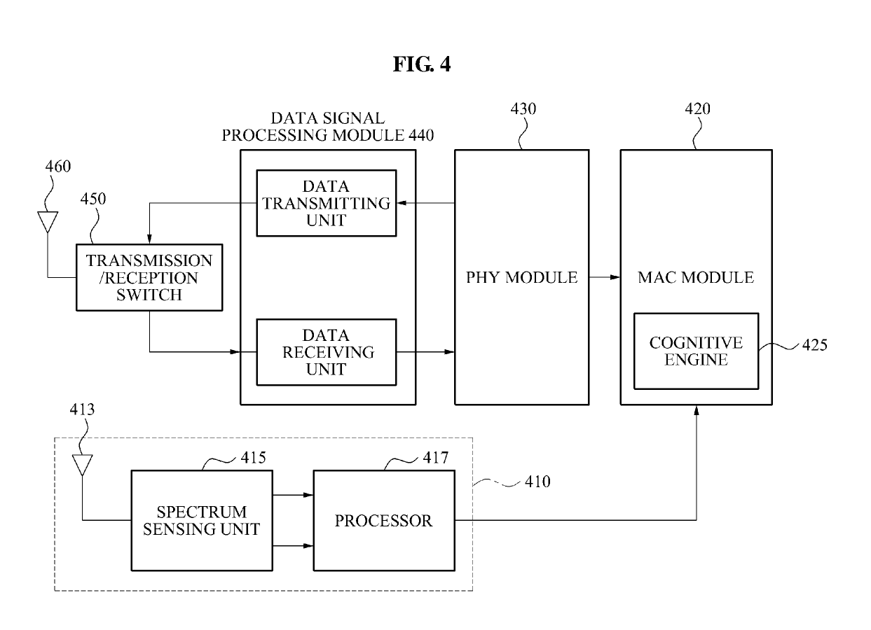

FIG. 4 illustrates a CR system including a multi-path spectrum sensing apparatus according to an embodiment of the present invention.

Referring to FIG. 4, the CR system according to an embodiment of the present invention may include a multi-path spectrum sensing apparatus 410, a Media Access Control layer (MAC) module 420, and a physical layer (PHY) module 430.

The CR system according to an embodiment of the present invention may further include a data signal processing module 440, a transmission/reception switch 450, and an antenna 460.

The multi-path spectrum sensing apparatus 410 may determine an occupation state of a channel.

The multi-path spectrum sensing apparatus 410 may include a spectrum sensing unit 415 and a processor 417. The spectrum sensing unit 415 may sense at least one spectrum from an RF input signal using at least one of a broadband filter and a narrowband filter, and the processor 417 may determine an occupation state of a channel corresponding to the at least one spectrum.

Functions of the multi-path spectrum sensing apparatus 410 may be the same as the multi-path spectrum sensing apparatus 100 of FIG. 1 and thus, omitted descriptions thereof may be understood based on the descriptions of FIG. 1.

The MAC module 420 may process information, for example, an occupation state of a channel, received signal strength indicator (RSSI), a type of frequency, a type of signal, and the like, received from the multi-path spectrum sensing apparatus 410, to allocate a spectrum that is available for a communication, such as a spectrum that is not occupied and a spectrum that does not include interference.

The MAC module 420, more specifically, the cognitive engine 425, may allocate at least one available spectrum band based on the occupation state of the channel.

The MAC module 420 may set a priority of the channel based on the occupation state of the channel and may allocate the at least one spectrum band based on the priority.

The PHY module 430 may set a channel based on the at least one spectrum band allocated from the MAC module 420.

The PHY module 430 may reset the data signal processing module 440 including the data transmitting unit and the data receiving unit based on at least one portion of the available spectrum For example, the PHY module 430 may control the data signal processing module 440 controlling a transmission power with respect to the data transmitting unit or may perform tuning of a filter with respect to the data receiving unit to enable the data receiving unit to operate within a predetermined frequency range.

When data is transmitted or received via the antenna 460, the transmission/reception switch 450 may perform a switching to transmit or to receive data of the data signal processing module 440.

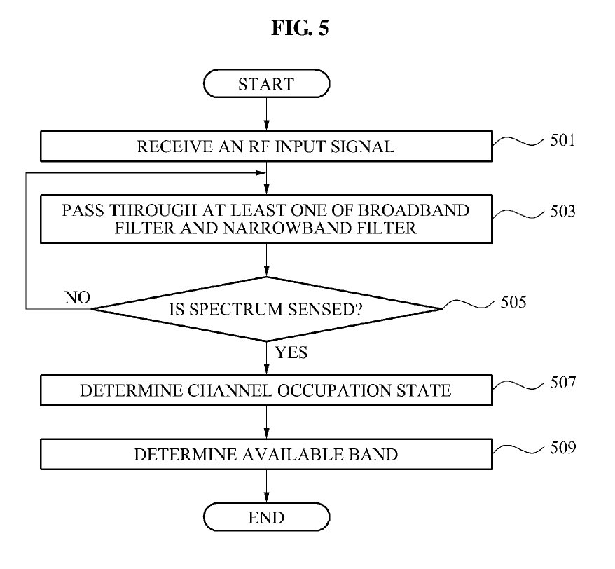

FIG. 5 illustrates a multi-path spectrum sensing apparatus for a CR system according to an embodiment of the present invention.

Referring to FIGS. 4 and 5, while the data signal processing module 440 of the CR system of FIG. 4 operates, an RF input signal is received via the antenna 413 in operation 501 and is provided to the spectrum sensing unit 415.

The spectrum sensing unit 415 passes the RF input signal through at least one of a broadband filter and a narrowband filter to sense at least one spectrum in operation 503.

In this case, the RF input signal may pass the RF input signal through each of the broadband filter and at least one narrowband filter to sense the at least one spectrum.

A filtering band of the broadband filter may be the same as a band available for the CR system.

The narrowband filter may be designed for filtering a well-known signal, for example, a pilot signal, and may have a predetermined filtering band.

The narrowband filter may be constituted of at least one narrowband filter, namely, one or more narrowband filters, and may have a variable center frequency and a variable bandwidth. Prior to operation 503, operation 501 where the processor 417 generates a control signal for adaptively controlling the center frequency and bandwidth of the narrowband filter may be performed. Therefore, when the at least one spectrum is sensed in operation 503, the center frequency and the bandwidth of the narrowband filter may be adjusted based on the control signal to sense the at least one spectrum.

In this case, when at least one spectrum is not sensed, the spectrum sensing unit 415 again passes the received RF input signal through the filters to continuously sense a spectrum in operation 505.

When at least one spectrum is sensed in operation 505, the processor 417 may determine the occupation state of a channel corresponding to the at least one spectrum in operation 507.

The cognitive engine 425 of the MAC module 420 may allocate at least one available spectrum band based on the occupation state of the channel received from the multi-path spectrum sensing apparatus 410.

The multi-path spectrum sensing method according to an embodiment of the present invention may include operations sequentially processed in the multi-path spectrum sensing apparatus and the CR system described with reference to FIGS. 1 through 4.

Therefore, the multi-path spectrum sensing apparatus and the CR system described with reference to FIGS. 1 through 4 may be applied to the multi-path spectrum sensing method according to an embodiment of the present invention.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A multi-path spectrum sensing apparatus for a cognitive radio (CR) system, the apparatus comprising:
a spectrum sensing unit to sense at least one spectrum from a radio frequency (RF) input signal, using at least one of a broadband filter and a narrowband filter; and
a processor to determine an occupation state of a channel corresponding to the at least one spectrum.

2. The apparatus of claim 1, wherein the spectrum sensing unit senses the at least one spectrum from the RF input signal by passing the RF input signal through each of the broadband filter and the narrowband filter.

3. The apparatus of claim 1, wherein a filtering band of the broadband filter is the same as a band available for the CR system.

4. The apparatus of claim 1, wherein the narrowband filter is constituted of at least one narrowband filter, and has a variable center frequency and a variable bandwidth.

5. The apparatus of claim 1, wherein the processor comprises:
a control signal generator to generate a control signal to adaptively adjust a center frequency and a bandwidth of the narrowband filter.

6. The apparatus of claim 5, wherein the spectrum sensing unit adjusts the center frequency and the bandwidth of the narrowband filter based on the control signal received from the processor.

7. The apparatus of claim 1, wherein the processor determines an occupation state of the channel and a type of the channel based on a Cyclostationary algorithm.

8. A CR system, comprising:
a multi-path spectrum sensing apparatus to determine an occupation state of a channel;
a Media Access Control layer (MAC) module to allocate at least one available spectrum band based on the occupation state of the channel; and
a physical layer (PHY) module to set a channel based on the at least one allocated spectrum band.

9. The system of claim 8, wherein the multi-path spectrum sensing apparatus comprises:
a spectrum sensing unit to sense at least one spectrum from an RF input signal based on at least one of a broadband filter and a narrowband filter; and
a processor to determine an occupation state of the channel corresponding to the at least one spectrum.

10. The system of claim 9, wherein the spectrum sensing unit comprises sensing the at least one spectrum from the RF input signal by passing the RF input signal through each of the broadband filter and the narrowband filter.

11. The system of claim 9, wherein the narrowband filter is designed for filtering a well-known signal and has a predetermined filtering band.

12. The system of claim 9, wherein the processor generates a control signal to adaptively adjust a center frequency and a bandwidth of the narrowband filter.

13. The system of claim 12, wherein the spectrum sensing unit adjusts the center frequency and the bandwidth of the narrowband filter based on the control signal received from the processor.

14. The system of claim 8, wherein the MAC module sets a priority of the channel based on the occupation state of the channel, and allocates at least one spectrum band based on the set priority.

15. A multi-path spectrum sensing method for a CR system, the method comprising:
sensing at least one spectrum from an RF input signal based on at least one of a broadband filter and a narrowband filter; and
determining an occupation state of a channel corresponding to the at least one spectrum.

16. The method of claim 15, wherein the sensing comprises sensing the at least one spectrum from the RF input signal by passing the RF input signal through each of the broadband filter and the narrowband filter.

17. The method of claim 15, wherein a filtering band of the broadband filter is the same as a band available for the CR system.

18. The method of claim 15, wherein the narrowband filter is constituted of at least one narrowband filter, and has a variable center frequency and a variable bandwidth.

19. The method of claim 15, further comprising:
generating a control signal to adaptively adjust the center frequency and bandwidth of the narrowband filter.

20. The method of claim 19, wherein the sensing comprises sensing the at least one spectrum by adjusting the center frequency and the bandwidth of the narrowband filter based on the control signal.
